(19) United States
(12) Patent Application Publication
(10) Pub. No.: US 2008/0240103 A1
(43) Pub. Date: Oct. 2, 2008

(54) Three-port ethernet switch with external buffer

(76) Inventor: Andreas Schmidt, St. Augustin (DE)

Correspondence Address: SLATER & MATSIL LLP, 17950 PRESTON ROAD, SUITE 1000, DALLAS, TX, 75252, US

(21) Appl. No.: 11/731,035

(22) Filed: Mar. 30, 2007

(51) Int. Cl. H04L 12/56

(52) U.S. Cl. 370/392; 370/401

(57) ABSTRACT

System and method for routing data packets in an Ethernet switch. A preferred embodiment comprises receiving a data frame at a first port, wherein the data frame comprises a header portion and payload portion. The header portion is analyzed to determine a destination port for the data frame. A destination status is added to the header portion to create a modified header portion. The modified header portion is stored in an on-chip memory. The payload portion is stored in an off-chip memory. An on-chip CPU instructs a DMA controller how to route the data frame.

### TECHNICAL FIELD

The present invention relates generally to a system and method for switching Ethernet packets and, more particularly, to a system and method for buffering Ethernet frame header data on-chip while buffering payload data off-chip.

### BACKGROUND

Generally, Internet protocol (IP) phones include a feature rich three-port Ethernet switch. The ports on the Ethernet switch are coupled to an on-chip CPU and, off-chip, to a local area network (LAN) and a personal computer (PC). All the traffic for the PC goes through the IP phone switch. Typical traffic distribution is for most of the packets to get switched between the PC and LAN port and for minimal packets, such as for voice and phone management data, to be switched to the CPU port. In order to reduce the load on the CPU, the traffic switched between the PC and LAN ports is processed in hardware, which requires several 10 kB of on-chip buffer along with complex buffer management hardware. The Ethernet switch consumes a considerable amount of chip area due to its on-chip buffer requirements.

One disadvantage of the prior art is the need for on-chip buffers and buffer management hardware. These buffers require large amounts of chip area and are used to hold data that is not required for on-chip processing or route determination.

A second disadvantage of the prior art is that the Ethernet switch does not use external memory, such as SDRAM that is typically available on the same PCB as the Ethernet switch.

### SUMMARY OF THE INVENTION

These and other problems are generally solved or circumvented, and technical advantages are generally achieved, by preferred embodiments of the present invention which uses both on-chip SRAM memory and off-chip SDRAM memory to buffer packets that are being routed through an Ethernet switch. By reducing the use of on-chip buffers, the area required for the Ethernet-enabled chip can be reduced significantly.

An on-chip DMA controller handles the packets that are passed between the PC and LAN ports. The DMA controller buffers the header data to on-chip SRAM where it can be quickly accessed by the on-chip CPU. The DMA controller buffers the bulk of the Ethernet frame, including the payload data, to the off-chip SDRAM. The CPU processes the header data and instructs the DMA controller where to route the packets. The DMA controller handles transfer of the packets from the SRAM and SDRAM to the destination port.

The present invention minimizes the CPU involvement by hardware to determine packet destination. A hardware MAC table and an optional VLAN table are used to determine the packet destination and then the packet header is modified with the destination port information before being stored to on-chip SRAM. The CPU looks at the header information in the SRAM to determine the packet's destination and then instructs the DMA controller how to route the packet. This allows CPU to use minimum MIPS to forward packets between ports.

In accordance with a preferred embodiment of the present invention, a method for processing packets comprises receiving a data frame at a first port, wherein the data frame comprises a header portion and payload portion, analyzing the header portion to determine a destination port for the data frame, adding a destination status to the header portion to create a modified header portion, storing the modified header portion in an on-chip memory; and storing the payload portion in an off-chip memory. The method further comprises analyzing the modified header portion by an on-chip CPU, and instructing a DMA controller where to route the data frame. The DMA controller routes the header portion and the payload portion to the destination port. The header portion is analyzed by on-chip hardware, such as a MAC table or a VLAN table, to determine the destination port. An error status is added to the payload portion that is stored in the off-chip memory. The on-chip memory is SRAM memory and the off-chip memory is SDRAM memory.

In accordance with another preferred embodiment of the present invention, a system for switching packets comprises a first Ethernet MAC coupled to a local area network (LAN) port, a second Ethernet MAC coupled to a personal computer (PC) port, a hardware MAC table coupled to both the first and second Ethernet MACs, and a DMA controller coupled to the first and second Ethernet MACs and to an SRAM memory, wherein the first and second Ethernet MACs, the MAC table, the DMA controller and the SRAM memory are all located on a single chip, and wherein the DMA controller is also coupled to an off-chip SDRAM memory. The system further comprises a CPU located on the chip and coupled to the DMA controller and the SRAM memory. The MAC table is used to determine a destination for data packets received by the first and second Ethernet MACs. The DMA controller operates to store packet header data to the SRAM memory and to store packet payload data to the SDRAM memory. The CPU instructs the DMA controller how to route packets that are received by the first Ethernet MAC and the second Ethernet MAC. The system further comprises a VLAN table coupled to both the first and second Ethernet MACs, wherein the VLAN table is constructed on the chip and wherein the VLAN table is used to determine a destination for data packets received by the first and second Ethernet MACs.

In accordance with another preferred embodiment of the present invention, a method of operating a DMA controller constructed on a chip comprises receiving data packets from an Ethernet MAC, storing a header portion of the data packets to a first memory, wherein the first memory is constructed on the chip with the DMA controller, and storing a payload portion of the data packets to a second memory, wherein the second memory is separate from the chip containing the DMA controller and the first memory. The method further comprises notifying a CPU when a header portion is stored to the first memory, wherein the CPU is constructed on the chip, and receiving routing instructions from the CPU, wherein the routing instructions identify a port to which the header portion and the payload portion are transmitted. The CPU creates the routing instructions based upon a destination status word in the header portion of the data packets. The Ethernet MAC adds the destination status word to the header portion of the data packets.

An advantage of a preferred embodiment of the present invention is a significant reduction in chip area by moving the payload buffering to off-chip SDRAM.

A further advantage of a preferred embodiment of the present invention is minimizing the CPU instructions that are needed to route packets.

### BRIEF DESCRIPTION OF THE DRAWINGS

For a more complete understanding of the present invention, and the advantages thereof, reference is now made to the following descriptions taken in conjunction with the accompanying drawing, in which:

FIG. 1 is an Ethernet switch chip incorporating embodiments of the present invention;

FIG. 2 is an example of an Ethernet frame;

FIG. 3 is an Ethernet frame header modified according to embodiments of the present invention;

FIG. 4 is an Ethernet frame payload modified according to embodiments of the present invention; and

FIG. 5 illustrates how the Ethernet frame header and Ethernet frame payload are stored to SRAM and SDRAM according to embodiments of the present invention.

### DETAILED DESCRIPTION OF ILLUSTRATIVE EMBODIMENTS

Presently preferred embodiments of the invention are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

The present invention is described with respect to preferred embodiments in a specific context, namely a thee-port 10/100 Mbit/s Ethernet switch in a system on a chip (SoC) environment for an IP phone application. For a 10/100 Mbit/s Ethernet switch, this approach gives wire-speed switching with minimal MIPS performance required from the CPU. The invention may also be applied, however, to Ethernet switches in other applications.

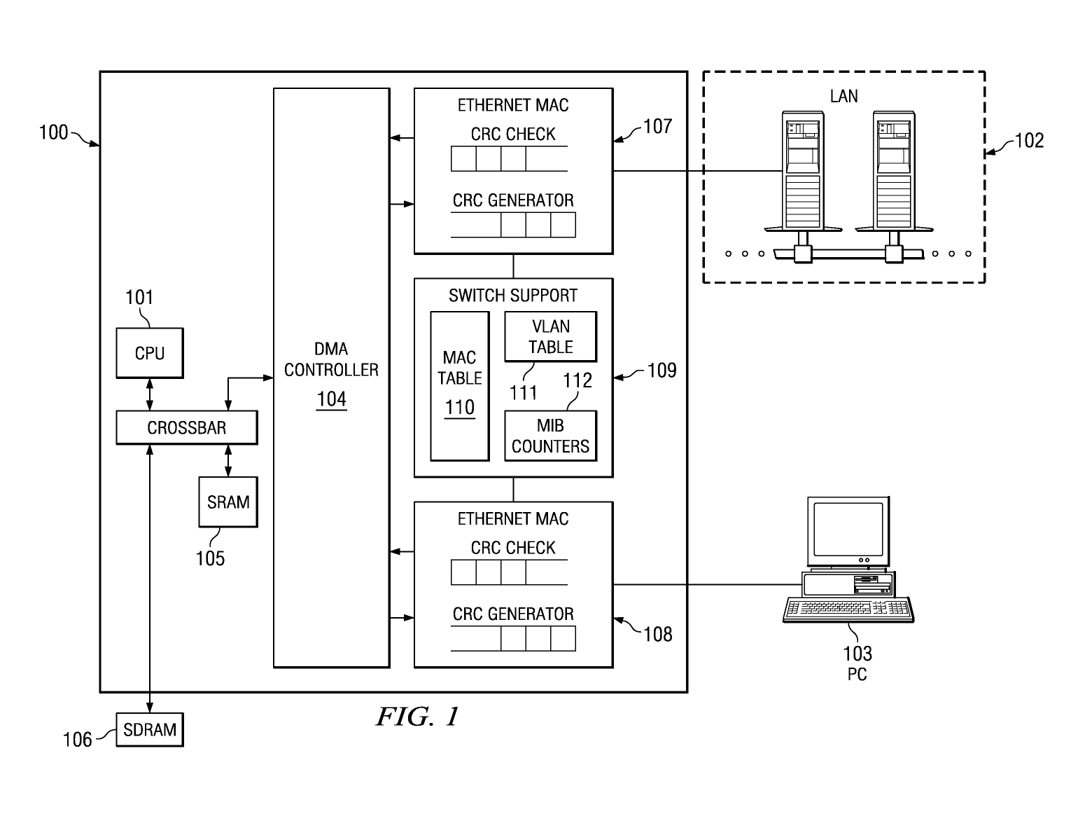

FIG. 1 illustrates Ethernet switch chip 100, which incorporates features of a three-port Ethernet switch for use in an IP phone. Chip 100 has an internal port coupled to on-chip CPU 101 and two external ports coupled to LAN 102 and PC 103, respectively. Ethernet packet transfer is handled by on-chip DMA controller 104. In embodiments of the present invention, DMA controller 104 stores the headers for Ethernet packets in on-chip SRAM 105 and stores the remaining portion of the Ethernet packet to external SDRAM 106. DMA controller 104 has scatter/gather capability that allows it to split the Ethernet packets and spread them into multiple locations, such as SRAM 105 and SDRAM 106.

The present invention provides considerable chip area reduction by moving most of the switch buffering from on-chip SRAM memory 105 to external SDRAM memory 106. The actual switching from a receive DMA queue to a transmit DMA queue is done by CPU 101 within a small, prioritized routine. In order to minimize CPU 101 involvement, switching decisions are performed in hardware using MAC table 110 and/or VLAN table 111. LAN 102 is coupled to Ethernet MAC 107, and PC 103 is coupled to Ethernet MAC 108. Ethernet MACs 107 and 108 are responsible for CRC generation and CRC checking. Ethernet MACs 107 and 108 have buffers to store the Ethernet packet header so that the MAC address and VLAN field can be evaluated on the fly. The packet destination is then added to the packet status header.

Ethernet MACs 107 and 108 use switch support hardware 109 to identify the packet destination. MAC table 110 evaluates the packet's destination MAC address and VLAN table 111 evaluates the optional VLAN tag to determine the destination port(s) to which the packet should be forwarded. The destination field “DST_PORT[2:0]” is written to a status word that is added to the front of the Ethernet packet header. Switch support 109 evaluates the packet's source MAC address for MAC address learning and aging. Switch support 109 also includes managed information base (MIB) counters 112 which count packets that are dropped, for example, due to short packet, collision, excessive collisions, etc.

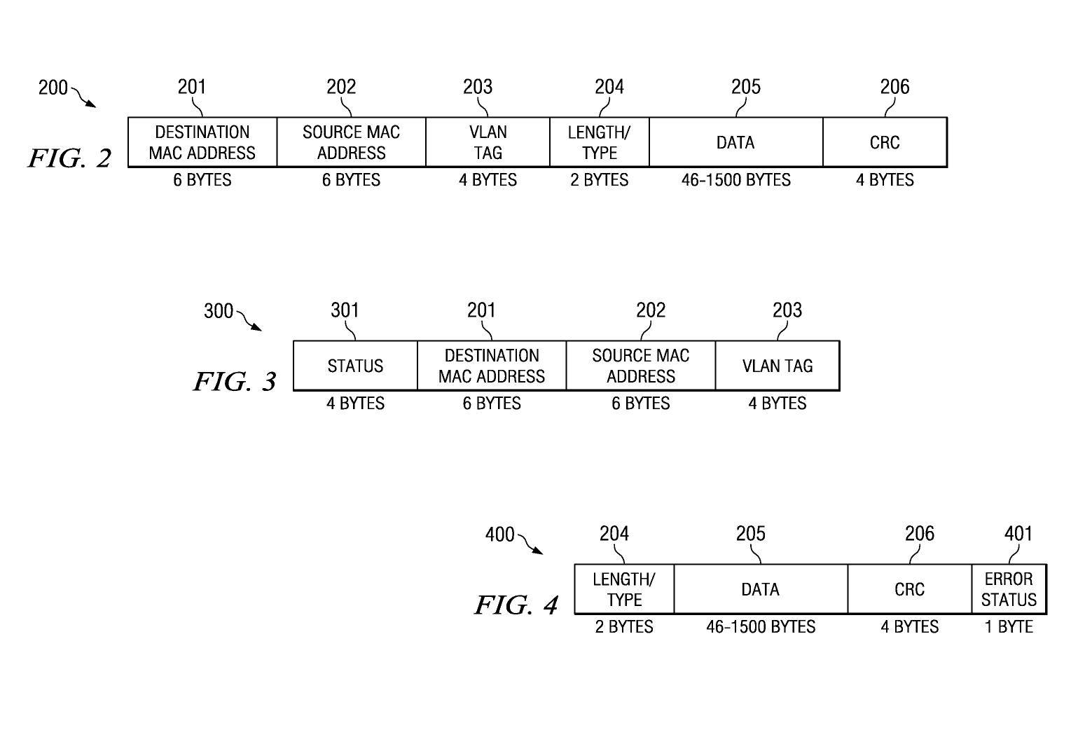

FIG. 2 illustrates the fields of Ethernet frame 200, which may be processed by Ethernet switch chip 100. Destination MAC address 201 identifies one or more recipient nodes for frame 200. Source MAC address 202 identifies the sender of packet 200. Optional VLAN tag 203 associates the frame with a particular VLAN so that a system can indicate the VLAN to which a frame should be sent. Length/type field 204 identifies the type of protocol being carried and may also indicate the length of the data part. Field 204 may also be used to indicate when a tag field is added to frame 200. Data field 205 carries the data payload for frame 200. CRC field 206 is a cyclic redundancy check or frame check sequence that provides error detection in the case where line errors or transmission collisions result in corruption of the frame. Fields 201-203 are used for switching packet 200 and, therefore, are the relevant fields to switch chip 100. Ethernet switch 100 does not need to know the content of fields 204-206 in order to route frame 200. Therefore, it is not necessary for CPU 101 to receive these fields. Accordingly, in the present invention, frame 200 is broken into two parts and fields 201-203 are stored in on-chip SRAM 105 to allow fast access by CPU 101. The remaining fields, 204-206, which include the bulk of the frame data are stored to off-chip SDRAM 106.

When an Ethernet frame, such as frame 200, is received by switch 100, switch support hardware 109 evaluates the destination MAC address and optional VLAN tag to determine the destination port(s) to which the frame should be forwarded. MAC table hardware 110 prepends a status word to the frame header, such as status field 301 (FIG. 3) which has been added to header 300. Status word 301 identifies the destination port that has been defined for incoming frame 200. DMA controller 104 stores header 300 to on-chip SRAM 105 and notifies CPU 101 that a new frame has arrived. CPU 101 looks at header 300 in SRAM 105 to determine the destination for frame 200 and then sets up a descriptor to direct where DMA controller 104 should route the packets.

When DMA controller 104 stores header 300 to on-chip SRAM 105, it also stores the remaining fields of frame 200 to off-chip SDRAM 106. FIG. 4 illustrates the payload fields 400 that are stored to off-chip SDRAM 106 as packet 400. Ethernet MAC 107 and 108 adds error status byte 401 to packet 400. Error status field 401 allows the packet to be marked as erroneous, such as for CRC error or oversize error, on the fly during or after the transfer to SDRAM memory 106. This arrangement minimizes delay by allowing the packets to be written straight to RAM without having to wait for an error check by the hardware. If the MAC hardware detects an error, it can mark the packet using error status field 401.

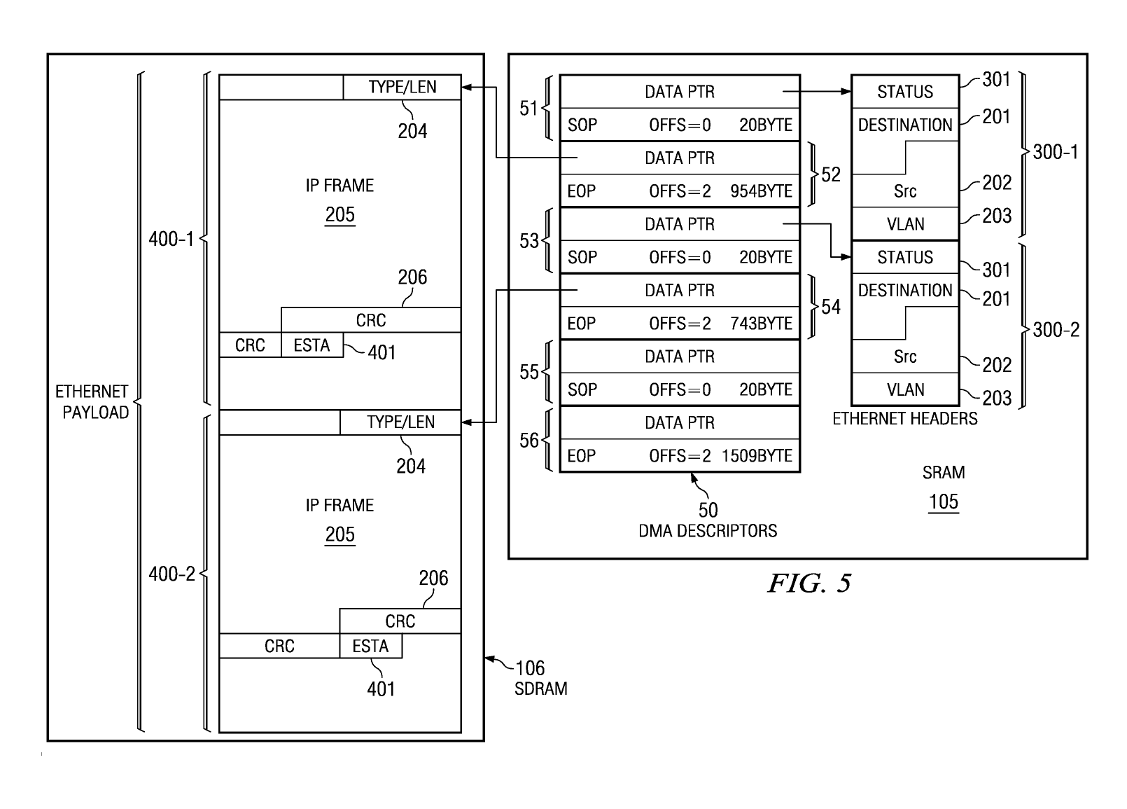

FIG. 5 illustrates how the payload and header portion of frame 200 are stored to memories 105 and 106. For each frame 200, DMA controller 104 strips off the header and the MAC/VLAN status word portion 300 and stores it in SRAM 105. Multiple headers 300-1, 300-2, etc. can be stored in SRAM 105. DMA controller 104 stores Ethernet frame payload portion and error status 400 to SDRAM 106. Multiple payloads 400-1, 400-2, etc. can be stored to SDRAM 106. DMA descriptor table 50 is used to link the memory locations together for a single DMA operation. For example, descriptor 51 includes a data pointer that points to the location of header 300-1. Descriptor 51 also indicates that the header data is a start of packet (SOP) with zero offset and is 20 bytes long. Descriptor 52 points to the location of payload 400-1, which is paired with header 300-1. Descriptor 52 indicates that the data is an end of packet (EOP) and is 954 bytes long. Descriptor 52 also indicates that a two byte offset should be used to align the data in memory. Similarly, descriptors 53 and 54 point to header 300-2 and payload 400-2, respectively. Descriptors 55 and 56 point to additional header and payload information (not shown) that is stored in SRAM 105 and SDRAM 106.

The header data (300-1, 300-2, etc.) that on-chip CPU 101 needs to access is stored in on-chip SRAM 105, which has a faster time compared to off-chip SDRAM 106. In particular, CPU 101 needs fasts access to Ethernet header status word 301, which holds the destination port information, and to DMA descriptor table 50, which are manipulated by CPU 101 to actually forward the packets to a transmit DMA channel. In embodiments where the VLAN tag with priority field is used, CPU 101 also accesses VLAN tag 203. In an alternative embodiment, CPU 101 also monitors error status byte 401, such as by an error flag (not shown) that is appended to the DMA descriptor EOP field. The SRAM header data 300 consists of 20 bytes in VLAN-aware mode or 16 bytes in VLAN-unaware mode.

When the header is presented to a transmit DMA channel from SRAM 105, status word 301 is omitted. This may be accomplished by incrementing the data pointer to the next 32-bit word and reducing the header length by 4 bytes. In VLAN-aware mode, VLAN tag 203 can be optionally removed by reducing the header length by an additional 4 bytes.

CPU 101 receives an interrupt for each incoming packet. A worst case operating scenario would occur if CPU 101 received the smallest possible packets back-to-back, for example, receiving 64-byte packets with a 12-byte inter-packet gap. At 100 Mbit/s this scenario would result in an interrupt every 6 us per port. If both ports received such packets, CPU 101 would receive interrupts every 3 us. Allowing an interrupt to be issued for every packet leads to a non-deterministic interrupt load. In a preferred embodiment, the system is designed to provide a deterministic interrupt load, such as by using a 6 us interrupt timer that prompts CPU 101 to look at the DMA queue at consistent intervals no matter what the traffic load is like. An interrupt timer of greater than 6 us may require increased buffering, which introduces switching latency and makes flow control more difficult.

Although the present invention and its advantages have been described in detail, it should be understood that various changes, substitutions and alterations can be made herein without departing from the spirit and scope of the invention as defined by the appended claims. For example, many of the features and functions discussed above can be implemented in software, hardware, or firmware, or a combination thereof. As another example, it will be readily understood by those skilled in the art that the MAC table may be implemented in software or otherwise may be varied while remaining within the scope of the present invention.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method for processing packets, comprising:
receiving a data frame at a first port, wherein the data frame comprises a header portion and payload portion;
analyzing the header portion to determine a destination port for the data frame;
adding a destination status to the header portion to create a modified header portion;
storing the modified header portion in an on-chip memory; and
storing the payload portion in an off-chip memory.

2. The method of claim 1, further comprising:
analyzing the modified header portion by an on-chip CPU; and
instructing a DMA controller where to route the data frame.

3. The method of claim 2, further comprising:
routing, by the DMA controller, the header portion and the payload portion to the destination port.

4. The method of claim 1, wherein the header portion is analyzed by on-chip hardware to determine the destination port.

5. The method of claim 4, wherein the hardware is a MAC table.

6. The method of claim 4, wherein the hardware is a VLAN table.

7. The method of claim 1, further comprising:
adding an error status to the payload portion that is stored in the off-chip memory.

8. The method of claim 1, wherein the on-chip memory is SRAM and the off-chip memory is SDRAM.

9. A system for routing packets, comprising:
a first Ethernet MAC coupled to a local area network (LAN) port;
a second Ethernet MAC coupled to a personal computer (PC) port;
a hardware MAC table coupled to both the first and second Ethernet MACs; and
a DMA controller coupled to the first and second Ethernet MACs and to an SRAM memory,
wherein the first and second Ethernet MACs, the MAC table, the DMA controller and the SRAM memory are all located on a single chip, and wherein the DMA controller is also coupled to an off-chip SDRAM memory.

10. The system of claim 9, further comprising:
a CPU located on the chip and coupled to the DMA controller and the SRAM memory.

11. The system of claim 9, wherein the MAC table is used to determine a destination for data packets received by the first and second Ethernet MACs.

12. The system of claim 9, wherein the DMA controller operates to store packet header data to the SRAM memory and to store packet payload data to the SDRAM memory.

13. The system of claim 10, wherein the CPU instructs the DMA controller how to route packets that are received by the first Ethernet MAC and the second Ethernet MAC.

14. The system of claim 9, further comprising:
a VLAN table coupled to both the first and second Ethernet MACs, wherein the VLAN table is constructed on the chip.

15. The system of claim 14, wherein the VLAN table is used in conjunction with the MAC table to determine a destination for data packets received by the first and second Ethernet MACs.

16. A method of operating a DMA controller constructed on a chip, comprising:
receiving data packets from an Ethernet MAC;
storing a header portion of the data packets to a first memory, wherein the first memory is constructed on the chip with the DMA controller; and
storing a payload portion of the data packets to a second memory, wherein the second memory is separate from the chip containing the DMA controller and the first memory.

17. The method of claim 16, further comprising:
notifying a CPU when a header portion is stored to the first memory, wherein the CPU is constructed on the chip.

18. The method of claim 17, further comprising:
receiving routing instructions from the CPU, wherein the routing instructions identify a port to which the header portion and the payload portion are transmitted.

19. The method of claim 18, wherein the CPU creates the routing instructions based upon a destination status word in the header portion of the data packets.

20. The method of claim 19, wherein the Ethernet MAC adds the destination status word to the header portion of the data packets.
